(19) United States
(12) Patent Application Publication
(10) Pub. No.: US 2015/0241304 A1
(43) Pub. Date: Aug. 27, 2015

(54) METHOD FOR THE COMPUTER-ASSISTED MONITORING OF THE OPERATION OF A TECHNICAL SYSTEM, PARTICULARLY OF AN ELECTRICAL ENERGY-GENERATING INSTALLATION

(71) Applicant: SIEMENS AKTIENGESELLSCHAFT, München (DE)

(72) Inventors: Hans-Gerd Brummel, Berlin (DE); Kai Heesche, München (DE); Uwe Pfeifer, Berlin (DE); Volkmar Sterzing, Neubiberg (DE)

(21) Appl. No.: 14/427,418

(22) PCT Filed: Aug. 23, 2013
(86) PCT No.: PCT/EP2013/067517

§ 371 Date: Mar. 11, 2015

(30) Foreign Application Priority Data
Sep. 11, 2012 (EP) 12183930.2

(51) Int. Cl. G01M 15/05; G01M 15/14

(52) U.S. Cl. CPC G01M 15/05; G01M 15/14

(57) ABSTRACT

A method for computer-assisted monitoring of an electrical energy-generating installation, in which output variables (y(t)) of the installation are prognosticated using a data-driven model (NN) based on corresponding input variables (x(t)). A confidence measurement (C(t)) is determined for respective input variables (x(t)), using one or more density estimators (DE), this measurement being higher, the greater the similarity of the input variables (x(t)) to known input variables from training data with which the data-driven model (NN) and the density estimator (DE) are taught. Based thereon, an average weighted deviation (E(t)) is determined between the prognosticated output variables (y(t)) and the output variables (y⁰(t)) actually occurring. If the average weighted deviation (y(t)) exceeds a predetermined threshold (E^{Th}) successive times, an error in operation is detected and an alarm is issued.

Method for the computer-assisted monitoring of the operation of a technical system, particularly of an electrical energy-generating installation.

The invention relates to a method and a device for the computer-assisted monitoring of the operation of a technical system, particularly of an electrical energy-generating installation. The invention further relates to a corresponding technical system and a computer program product.

For the state monitoring of a technical system, such as e.g. an electrical energy-generating installation, and particularly a gas turbine, a multiplicity of process variables must be observed in order to obtain information from the current values of these variables to indicate whether the technical system is in the intended state. Permissible ranges exist for corresponding process variables which are defined by upper and lower limit values and are also continuously monitored in the operation of the technical system. However, these ranges are normally very wide and are left only in the event of serious malfunctions and failures of the technical system.

In order to detect malfunctions in a technical system which may, in the long term, result in damage to the system, it is known from the prior art to monitor the operation of the technical system in a computer-assisted manner on the basis of analytical process models. Thermodynamic processes, for example, are mapped through corresponding modelling equation systems which are then processed in a control center of the technical system for a real-time calculation. In real operation, corresponding reference values of output variables of the technical system based on current input variables of the system are output by the process models. The reference values are then compared with the process variables that have actually occurred and, in the event of substantial deviations, a malfunction of the technical system is detected or an alarm is output.

Analytical process models function very well for monitoring specific technical systems, but have some disadvantages and restrictions. In particular, the use of process models requires the existence of a corresponding model, which is not the case for all types of technical system. In order to achieve a high precision and selectivity of the state monitoring of the technical system, the model must have a high precision, which in turn incurs a high cost in terms of manpower and time in the creation of the model. The quality of a highly complex analytical process model depends above all on the mirroring of the configuration of the real technical system. Since technical systems, and particularly electrical energy-generating installations, are often configured in a customer-specific and site-specific manner, a detailed individual adaptation of the models is required for the specific technical systems, which is extremely time-consuming and costly. Moreover, if the configuration of the technical system is modified, e.g. if more energy-efficient units are installed, all variables and interrelationships thereby affected must be identified and updated in the analytical process model. Furthermore, the equation systems of analytical process models often contain numerous variables which can only be estimated or determined empirically, which in turn limits the precision of the model. Moreover, variables of this type may change over time, which in turn causes errors in the model calculation and can thus result in false alarms in the monitoring of the technical system.

The object of the invention is therefore to produce a simple and efficient method for the computer-assisted monitoring of a technical system.

This object is achieved by the independent patent claims. Further developments of the invention are defined in the dependent patent claims.

The method according to the invention is used for the computer-assisted monitoring of the operation of a technical system, particularly an electrical energy-generating installation and, particularly preferably a gas turbine. The technical system is characterized at corresponding operating times by a state vector comprising a number of input variables and at least one output variable which is to be monitored, wherein the number of input variables and the at least one output variable are operating variables of the technical system and/or variables which influence the operation of the technical system.

In a step a) of the method according to the invention, the at least one output variable is predicted for the respective operating times on the basis of input variables occurring in the operation of the technical system with a data-driven model which is trained by means of training data from known state vectors. The input variables occurring in the operation of the technical system comprise at least the input variables occurring at the respective operating time and may, where relevant, also contain input variables at further preceding times. In the method according to the invention, different data-driven models can be used to forecast the at least one output variable. In one particularly preferred embodiment, a neural network, in particular a recurrent neural network, is used. In particular, neural network structures which are described in documents [2], [3] and [4] can be used. The entire disclosure content of these documents is incorporated by reference into the present application.

In a step b) of the method according to the invention, one or more density estimators, which are trained by means of known input variables of the training data, are furthermore applied for respective operating times to the number of input variables at the corresponding operating time, whereby a confidence measure is defined which is higher the greater the similarity of the input variables at the corresponding operating time to known input variables from the training data. The density estimator(s) thus provide(s) information on how densely known input variables from the training data are present in the environment of the input variables used for the prediction. A high confidence measure thus represents a higher density in the data space of the input variables. Methods known per se from the prior art can be used as density estimators. In a particularly preferred embodiment, a neural cloud algorithm, which is described in document [6] and is also referred to as a data encapsulator, is used as a density estimator. The algorithm from document [6] is examined more closely in the detailed description. This algorithm is also used for density estimation in the method of document [5]. The entire disclosure content of documents [5] and [6] is incorporated by reference into the present application.

In a step c) of the method according to the invention, for respective cycles from a plurality of consecutive operating times, a weighted deviation, averaged over the number of state vectors in the respective cycle, between the at least one predicted output variable and the at least one output variable occurring in the operation of the technical system is defined, wherein state vectors whose number of input variables have low confidence measures are weighted less in the average weighted deviation. As described below, a threshold of the confidence measure can be introduced, where appropriate, wherein only confidence measures above the threshold are included in the average weighted deviation.

In a step d) of the method according to the invention, a malfunction of the technical system is detected if all average weighted deviations, for a number of consecutive cycles which is greater than a predefined numerical threshold, comprising one or more criteria, fulfil the criterion that the amount of these deviations exceeds a predefined threshold value. Where relevant, this criterion may be the only criterion for detecting a malfunction, insofar as the direction in which the value of the predicted output variable deviates from the actual output variable is irrelevant.

In one preferred embodiment of the invention, a malfunction is detected in step d) if all average weighted deviations for the number of consecutive cycles, which is greater than the predefined numerical threshold, fulfil the further criterion that they correspond to predicted output variables which are always smaller or always greater than the corresponding output variables occurring in the operation of the technical system. A fault is thus detected if the amount of the deviation not only lies above a threshold value, but also occurs in a specific direction. For specific output variables, such as e.g. the compressor efficiency of a gas turbine, only deviations in which the predicted output variable is exclusively smaller or exclusively greater than the output variable actually occurring in the operation of the technical system are relevant.

The method according to the invention has the advantage that the data-driven model that is used can easily be trained with training data and delivers accurate predictions for specific technical systems. In particular, data-driven models require little calculation time in the execution phase. An additional achievement of the method according to the invention is that predicted output variables originating from input variables which have little similarity to training data are incorporated to a lesser extent into the definition of the average weighted deviation, thereby increasing the reliability of the prediction or the detection of a malfunction of the technical system.

In one preferred embodiment, if a malfunction of the technical system is detected, an alarm is output and/or one or more precautionary measures are instigated to protect the technical system. The alarm may comprise the output of a signal, e.g. an audible and/or visual and/or haptic signal, and/or the sending of a message, e.g. an SMS and/or an email and the like. The precautionary measures may consist in load relief or total shutdown of the technical system.

The at least one output variable which is monitored with the method according to the invention may be any given operating variable or variable influencing the operation of the technical system. In particular, the output variable may comprise a measurement variable in the technical system and/or may be determined from one or more measurement variables in the technical system. The method according to the invention furthermore has the advantage that the output variable may be a variable regulated in the operation of the technical system which is maintained constant. This is possible, since the regulated variable is compared with a predicted regulated variable which may deviate from the regulated value in the event of system malfunctions.

In a further variant of the method according to the invention, the number of input variables contained in a respective state vector is defined on the basis of a trainable statistical model. In particular, the statistical model described in documents [1] and [2] can be used for this purpose. The entire disclosure content of documents [1] and [2] is incorporated by reference into the present application. Where relevant, it is also possible for the number of input variables which are contained in a respective state vector to be defined on the basis of expert knowledge.

As already mentioned above, the data-driven model used in the invention is preferably a neural network. Nevertheless, the method according to the invention may also be combined with data-driven models in the form of support vector machines and/or Gaussian processes.

In a further, particularly preferred embodiment of the method according to the invention, the average weighted deviation is defined in such a way that only state vectors whose number of input variables have confidence measures above a confidence threshold are taken into account in the average weighted deviation, wherein the state vectors taken into account in the average weighted deviation are preferably equally heavily weighted. Nevertheless, it is also possible for the individual deviations for the corresponding state vectors in the cycle to be multiplied by a factor which is greater, the greater the confidence measure of the corresponding input variables of the state vector is. Such a factor may, for example, be modelled by a function.

In a further advantageous variant of the method according to the invention, the predefined threshold value is defined by means of validation data comprising known state vectors at corresponding operating times, wherein the scatter of the deviations between the at least one output variable which is predicted with the trained data-driven model on the basis of input variables from the validation data and the at least one input variable which is contained in the state vector of the validation data at the corresponding operating time is defined from the validation data for respective operating times, wherein the predefined threshold is determined from the scatter of the deviations in such a way that the predefined threshold is greater, the greater the scatter is. The scatter is preferably represented by the standard deviation or variance of the frequency distribution of the deviations determined by means of the validation data, or the scatter depends on the standard deviation or the variance, wherein the predefined threshold preferably represents the standard deviation or the variance multiplied by a positive factor. It has become evident that a malfunction of the technical system can be very clearly distinguished from a normal operation with such a selection of the threshold value.

In one variant of the invention, a counter is incremented in step d) whenever the average weighted deviation fulfils the above criterion or criteria comprising the criterion that its amount exceeds a predefined threshold value for a cycle, wherein, with each incrementation of the counter, a warning is output and a malfunction of the technical system is furthermore detected if the incrementation of the counter indicates that the number of temporally consecutive cycles is greater than the predefined numerical threshold, wherein the counter is reset to an initial value if the average weighted deviation does not fulfil the criterion or criteria. As described above, the criteria may, where relevant, comprise the further criterion that the average weighted deviation corresponds to one or more predicted output variables which are always less than or always greater than the corresponding output variables occurring in the operation of the technical system.

In one preferred variant of the embodiment described above, different types of warning can be output depending on the number of consecutive cycles since the resetting of the counter in which the average weighted deviations fulfil the criterion or criteria. In this way, different levels of warnings can be implemented according to urgency.

By analogy with the alarm described above, the warning may also comprise the output of a signal, such as, for example, an audible and/or visual and/or haptic signal, and/or the sending of a message, such as, for example, an SMS and/or an email.

In a further design of the method according to the invention, a training of the data-driven model and/or the density estimator(s) is also repeated at predefined time intervals during the operation of the technical system with new state vectors as training data. In this way, the computer-supported monitoring method is modified adaptively during the operation of the technical system in line with newly added operating data.

In one particularly preferred embodiment, the operation of an electrical energy-generating installation comprising a gas turbine is monitored with the method according to the invention. However, the method may, where relevant, also be used for other energy-generating installations, e.g. steam turbines or wind turbines or wind power stations.

If the method according to the invention is used in combination with a gas turbine, the number of input variables and/or the at least one output variable comprise one or more of the following variables of the gas turbine:
the compressor efficiency of the gas turbine;
the turbine efficiency of the gas turbine;
the regulated exhaust gas of the gas turbine;
the setting of one or more guide vanes, particularly in the gas turbine compressor;
the rotational speed of the gas turbine;
one or more pressures and/or temperatures in the gas turbine, in particular the inlet temperature and/or the inlet pressure and/or the outlet temperature and/or the outlet pressure in the compressor and/or in the turbine;
the temperature in the environment in which the gas turbine is operated;
the relative humidity in the environment in which the gas turbine is operated;
the air pressure in the environment in which the gas turbine is operated;
one or more mass and/or volume flows;
one or more parameters of a cooling and/or auxiliary system and/or lubricating oil and/or bearing systems in the gas turbine, in particular the setting of one or more valves for the supply of cooling air;
the performance of the gas turbine, in particular a percentage performance value;
the fuel quality of the gas turbine;
the pollutant emission of the gas turbine, in particular the emission of nitrogen oxides and/or carbon monoxide;
the temperature of one or more turbine vanes of the gas turbine;
the combustion dynamics of the combustion chamber of the gas turbine;
the quantity of gas supplied to the gas turbine;
bearing and/or housing vibrations in the gas turbine.

The above variables have been known to the person skilled in the art for some time and are not therefore explained in detail. In one particularly preferred embodiment, the compression ratio of the gas turbine or the regulated exhaust gas temperature of the gas turbine is used as an output variable. In one further preferred embodiment, the setting of guide vanes in the compressor, the rotational speed of the gas turbine, the ambient humidity, the inlet pressure into the compressor, the inlet temperature into the compressor and a volume flow in the compressor when water is injected are used as input variables. The last-mentioned input variable is set to zero if no water is injected during the operation of the gas turbine.

As well as the method described above, the invention furthermore relates to a device for computer-assisted monitoring of the operation of a technical system and, in particular, an electrical energy-generating installation, wherein the device comprises a computer unit which is designed in such a way that the method according to the invention or one or more preferred variants of the method according to the invention can be carried out with the computer unit.

The invention furthermore comprises a technical system which contains the device according to the invention described above.

In addition, the invention relates to a computer program product with a program code stored on a machine-readable medium to carry out the method according to the invention or one or more preferred variants of the method according to the invention when the program code is executed on a computer.

Example embodiments of the invention are described in detail below with reference to the attached figures.

In the figures:

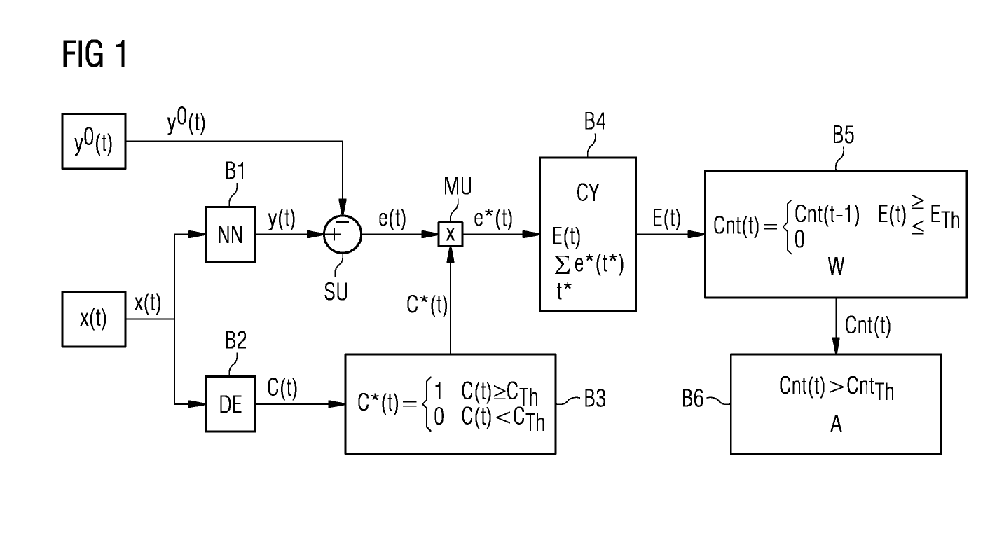

FIG. 1 shows a schematic representation of the process of an embodiment of the method according to the invention;

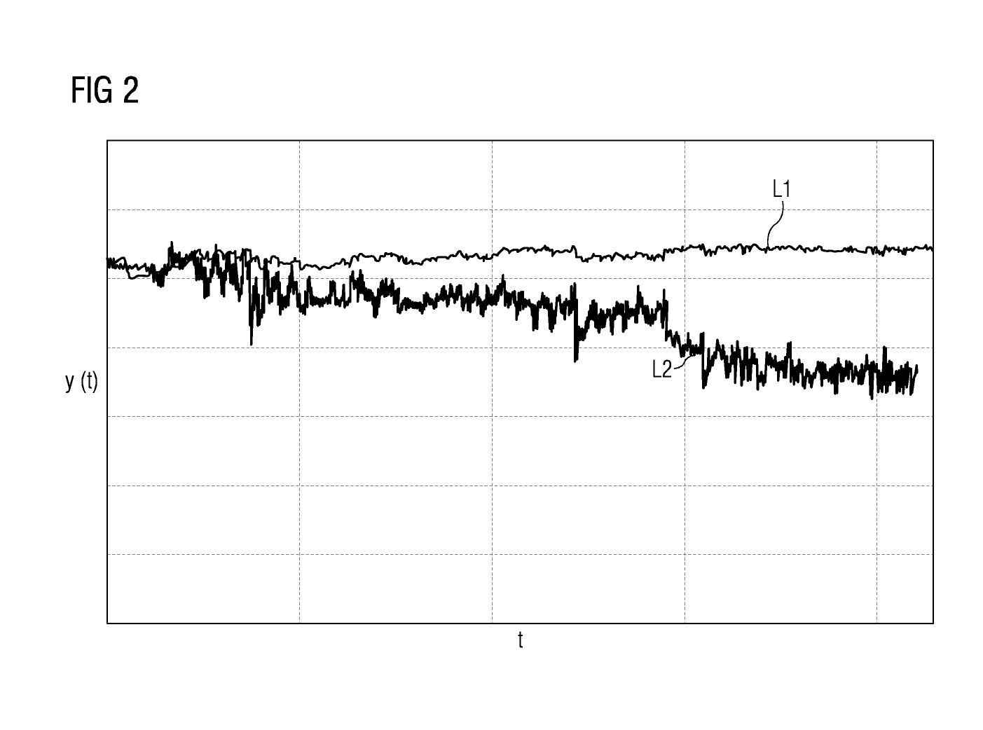

FIG. 2 shows a diagram illustrating the monitoring according to the invention of an unregulated operating variable of a technical system; and

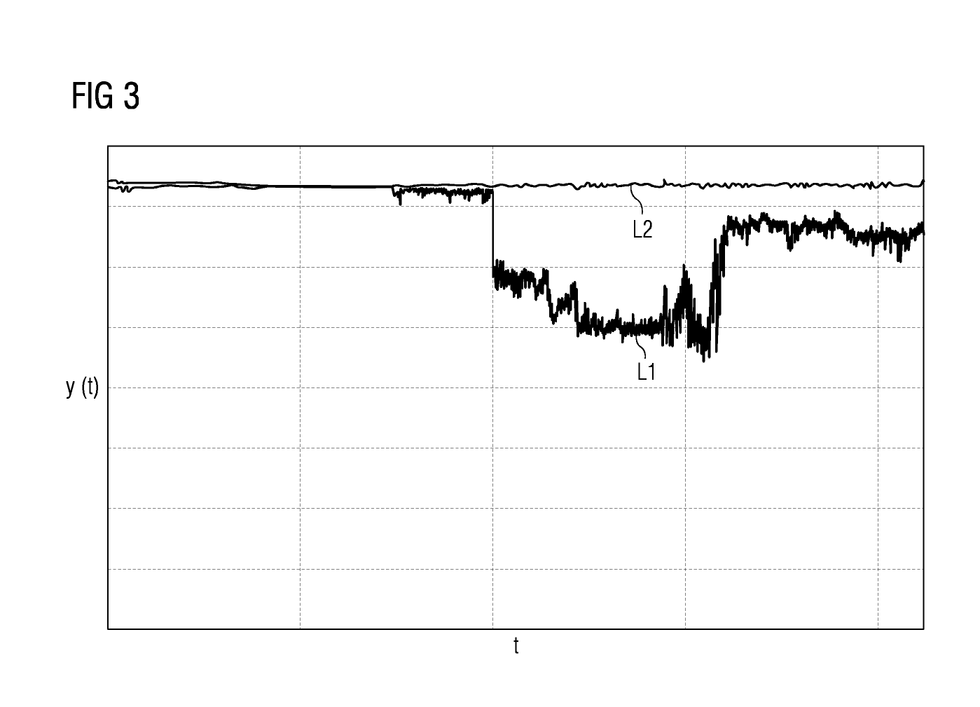

FIG. 3 shows a diagram illustrating the monitoring according to the invention of a regulated operating variable of a technical system.

An embodiment of the method according to the invention is described below in relation to the monitoring of a technical system in the form of a gas turbine. Nevertheless, the method according to the invention is also applicable to any other technical systems or electrical energy-generating installations, such as, for example, steam turbines or renewable energy-generating installations, for example wind power stations. With the method according to the invention, using computer-assisted methods, a soft sensor is implemented with which reference values of corresponding process variables of the technical system are determined. If these reference values deviate substantially from the actual process variables, a corresponding warning or, in the event of a persistent deviation, also an alarm is output, as described in detail below.

According to the flow diagram in FIG. 1, a number of input variables, which are denoted x(t) and relate to one or more operating variables of the gas turbine, are processed for the corresponding operating time t of the gas turbine. In addition, an output variable calculated or measured in the gas turbine at the corresponding operating time is processed in the form of a target variable y⁰(t). In one embodiment of the method according to the invention, which has also been tested by the inventors, the input variables x(t) are the following variables:
the position of the guide vanes in the gas turbine compressor;
the ambient humidity around the gas turbine;
the rotational speed of the turbine;
the inlet pressure of the gas turbine compressor;
the inlet temperature of the gas turbine compressor;
the mass flow of water which enters the compressor, in the case of an operation of the gas turbine in which water is injected into the compressor.

In one case, compressor efficiency, which is an intrinsically known variable and can be determined from corresponding pressures and temperatures in the compressor, is used as the corresponding output variable for the aforementioned input variables. In another case, the exhaust gas temperature (referred to as the OTC temperature) of the turbine was used as the output variable. In contrast to compressor efficiency, this variable is a variable which is regulated in the operation of the turbine and, as far as possible, is maintained at a constant value.

In the embodiment shown in FIG. 1, the input variables x(t) are processed, on the one hand, by a data-driven model in the form of a neural network NN (block B1) and, on the other hand, by a density estimator DE (block B2). Along with the input variables at the current operating time, input variables at further preceding operating times can, where relevant, also be incorporated into the neural network NN. The corresponding output variable y(t) which, as mentioned above, may represent, for example, the compressor efficiency or the exhaust gas temperature of the turbine, is predicted with the neural network NN. Any neural networks known from the prior art can be used to predict the variable y(t), such as, for example, multi-layer perceptron networks, recurrent neural networks and the like. For example, the neural network disclosed in document [3] can be used to predict the output variable y(t). Other methods, such as, for example, support vector machines or Gaussian processes, can also be used instead of neural networks to predict the output variable y(t).

The neural network NN was trained in advance with corresponding training data from state vectors comprising the known input variables and output variables for different operating times. The density estimator DE used in FIG. 1 outputs a confidence measure C(t) for the input variables x(t) for the current operating time, indicating whether the corresponding vector comprising input variables lies in a range of the state space of the input variables in which many vectors comprising known input variables of the training data occur. The density estimator was likewise suitably trained in advance with the training data.

In one particularly preferred embodiment, the data encapsulator DE from document [6], which is based on neural clouds, is used as the density estimator. The density estimation based on this method is known and is therefore only roughly outlined. The aim of the density estimation is to determine the “novelty” of a corresponding data set or data point from input variables at the corresponding operating time in terms of the extent to which further data sets of the training data are similar to the data set concerned, wherein the similarity is described by a distance between the data sets. This distance is given by the Euclidean distance of the data points in the data space. With the density estimator from document [6], a normalization of the individual data sets or data points is carried out on the basis of a min-max normalization method. A clustering of the data points is then carried out on the basis of a modification of the k-means algorithm known from the prior art, also referred to as the “advanced k-means” algorithm. This algorithm supplies cluster centers in the space of the data points. In a next step, Gaussian bells are laid over the centers, and a normalization of the Gaussian bells is then carried out. As the end result of the algorithm, a trained density estimator is then obtained which determines a confidence for a given data set from input variables, said confidence representing the similarity of the data set to data sets from the training data and being evaluated in the above document [6] as the failure probability for the technical system concerned.

In FIG. 1, the difference between the predicted output variable y(t) and the actually occurring output variable y° (t) is defined via the subtractor SU as the signed deviation or error e(t). The confidence measure C(t) determined via the data encapsulator DE, which is preferably between 0 and 1 (0 corresponds to no confidence and 1 to a very high confidence), is then further processed in block B3. A suitable threshold value C_{Th} is defined, wherein the value 0 is allocated to confidence measures below a threshold value CTh and the value 1 is allocated to confidence measures which are exactly as great as or are greater than the threshold value.

In this way, a weighted confidence measure C*(t) is defined which assumes either the value 0 or the value 1.

Finally, the weighted confidence measure C*(t) is multiplied via the multiplier MU by the error e(t) for the respective operating times t. In this way, a weighted error e*(t) is obtained which, in the case of a high confidence measure, corresponds to the original error e(t) and otherwise has the value 0. In a next step, which is indicated by the block B4, an average weighted error E(t) is determined for corresponding cycles CY from a predefined number of past operating times. This error is the sum of the errors e*(t) for the operating times in the cycle CY, divided by the number of operating times in the cycle CY. The calculation of E(t) is indicated in FIG. 1 via a corresponding sigma sign, wherein the summation is carried out over the number of times t* in the corresponding cycle CY. In order to define E(t), this sum must also be divided by the number of operating times in the cycle.

The average weighted error E(t) thus represents the average error between the predicted and actual output variable, taking into account the confidences C(t) output via the data encapsulator DE. If the confidence exceeds a defined measure, the corresponding prediction is trusted and is taken into account in the calculation of the average error. Otherwise, the corresponding prediction is rejected. In modifications of the method according to the invention, instead of a hard threshold C_{Th}, a function according to which the corresponding error e(t) is more or less substantially incorporated into the calculation of the average weighted error E(t) can be used. In particular, the confidence C(t) itself can, where relevant, be incorporated into the weighted sum of the errors as a weighting factor for the corresponding error e(t). Depending on the design of the method, the threshold C_{Th} can be selected in different ways. In one preferred embodiment, a value of C_{Th} at 0.95 has proven to be practicable.

The errors E(t) determined in the corresponding cycles CY are finally further processed in the block B5 shown in FIG. 1. There, it is determined whether the error E(t) exceeds or understeps a predefined threshold. Whether an exceeding or understepping of the error is detected depends on whether deviations are intended to be detected in which the target variable is less than or greater than the predicted variable. In the case of a target variable in the form of compressor efficiency, the only deviations which are considered to be critical are, for example, those in which the actual defined compressor efficiency y⁰(t) is less than the predicted compressor efficiency, since this indicates a malfunction in the gas turbine which may, in the long term, result in the total failure of the turbine. Nevertheless, in the method according to the invention, example embodiments are also possible in which both a positive and a negative deviation between the target variable and the predicted variable are classified as critical. In this case, it is determined in the block B5 whether the amount of the average error E(t) exceeds a corresponding (positive) threshold value E_{Th}.

If it is then established in the block B5 that the threshold value E_{Th} is exceeded or understepped for the corresponding cycle CY, a counter Cnt is incremented from its current counting value Cnt(t−1) by 1 to the new counting value Cnt(t). If, on the other hand, the threshold value E_{Th} is not exceeded or understepped, the counter is reset to 0. In addition, if the threshold value is exceeded or understepped, a corresponding warning W is output. For example, an audible signal can be output via a user interface in a control system for monitoring the gas turbine. Furthermore, it is also possible to send a corresponding SMS or email to the control system or to locations or persons responsible for the operation of the gas turbine. Where relevant, the type of the warning can be linked to the level of the value of the counter Cnt. Different warning levels can be defined in this way. For example, in the case of a low warning level, only an audible signal can be output, whereas, at higher warning levels, an SMS can first be sent, and finally an email.

The current counting value Cnt(t) is furthermore processed in the block B6. A check is carried out there to determine whether the counting value lies above a predefined numerical threshold Cnt_{Th}. If so, i.e. a deviation between the predicted and actual output variable has been present for some time, an alarm A is finally output which, depending on the embodiment of the method according to the invention, may be designed in different ways. In particular, in the event of an alarm, similar to the warning, a signal can be output or an SMS or an email can be sent. However, automatic precautionary measures of the control system are preferably also linked to the alarm. For example, a partial load relief of the gas turbine or a total load relief of the gas turbine can be effected through corresponding control of the generator of the turbine and, where appropriate, a stoppage of the turbine can also be effected. Where relevant, similar to the warnings, different alarm levels can also be defined depending on the level of the counting value.

In one preferred embodiment of the invention, the above threshold value E_{Th} for the average weighted deviation is defined on the basis of validation data which represent known state vectors comprising input variables and the output variable, but which were not used to train the neural network or the data encapsulator. The scatter of the deviations between an output variable, defined via the trained neural network and determined by means of corresponding input variables from the validation data, and the corresponding output variable is defined from the validation data. The scatter is preferably represented by the standard deviation of the frequency distribution of these deviations. The greater the standard deviation is, the higher the threshold E_{Th} is set in order hereby to avoid false alarms which result from a substantial scatter between the predicted and actual output variable. In one particularly preferred embodiment, the threshold E_{Th} corresponds to the product from the standard deviation and a factor which depends on the technical system considered or the data-driven model used. In the case where compressor efficiency is analyzed as the output variable, a factor with the value 3.5 has proven to be practicable. The numerical threshold Cnt_{Th} is preferably also set depending on this factor. For example, the numerical threshold can be set to double the value of the maximum value of the numerical value, which is reached in the evaluation of the validation data using the previously defined threshold value E_{Th}.

The monitoring method described with reference to FIG. 1 can be used to process any process management and comparison variables of technical systems and, in particular of fossil-fuelled thermoelectric power stations and their components. As already mentioned above, compressor efficiency, for example, can be used as the monitored output variable. Compressor efficiency is a very important virtual process variable which very closely reflects the state quality of the gas turbine compressor and represents a highly sensitive indicator of damage or other negative impairments of the gas turbine. However, compressor efficiency is subject to a range of influences, e.g. environmental conditions or the load state of the gas turbine, so that this efficiency can essentially lie within a very wide permissible value range. However, with the method according to the invention, a suitable reference value of this compressor efficiency is then determined depending on the operating conditions, on the basis of which malfunctions of the gas turbine can then be detected in good time before a total failure of the turbine.

The diagram in FIG. 2 shows a forecast, carried out with the method according to the invention, of an unregulated output variable y(t) which may, for example, be the compressor efficiency described above. The corresponding operating times t are plotted along the x-axis, and the output variable y(t) is plotted along the y-axis. The line L1 describes the predicted output variables and the line L2 describes the actually occurring output variables. As can be recognized, the scenario in FIG. 2 shows that the actual output variable is continuously smaller than the corresponding forecast. With the method according to the invention, a corresponding alarm can be output in the case where the forecast output variable is greater than the actual output variable by at least a predefined value over a prolonged period.

FIG. 3 shows a diagram similar to FIG. 2, wherein a regulated output variable is now processed which is maintained constant in the operation of the gas turbine. An output variable of this type is, for example, the exhaust gas temperature of the turbine which is normally regulated to a constant value. Consequently, the exhaust gas temperature is not conventionally suitable as an indicator of a malfunction of the gas turbine. Nevertheless, according to the invention, a regulated variable of this type can be used for state monitoring of the gas turbine, since this variable is compared with a forecast reference value, wherein an alarm is again output in the event of substantial deviations. In the scenario shown in FIG. 3, the change over time in the forecast output variable is indicated by the line L1 and the change over time in the regulated output variable is indicated by the line L2. Due to the regulation of the output variable, the line L2 essentially represents a constant value. Nevertheless, a substantial deviation from the regulated value occurs in part for the forecast value according to the line L1. In a case such as this, a corresponding alarm can be output.

The method according to the invention is applied predominantly to real and virtual process parameters for target groups of an electrical energy-generating installation. Particularly the machine types of gas turbine, steam turbine, boiler, generator and auxiliary systems represent target modules. The monitoring according to the invention is preferably carried out on the basis of thermodynamic success variables, such as temperatures, pressures, mass flows and volume flows, efficiency levels and the like. However, non-thermodynamic, deterministic processes, such as, for example, the vibration behavior of the target modules, can also be incorporated. In the case of a gas turbine, compressor efficiency in particular and compressor air mass flow can be used as process parameters in relation to the compressor. Turbine efficiency, for example, or turbine inlet temperatures can be considered as process variables for the turbine connected downstream of the compressor. Combustion dynamics (i.e. combustion chamber humming), the emissions of the gas turbine and the like can be used as process parameters for the combustion chamber of the gas turbine. In addition, horizontal and vertical bearing and housing vibrations (mean values of the amplitudes of the corresponding harmonics) can be used as process parameters. Particularly the fuel supply with valve setting, pressures and temperatures can be considered in relation to cooling or auxiliary systems of the gas turbine. Corresponding pressures, temperatures and volume flows can also be incorporated for the lubricating oil and bearing systems of the turbine.

The embodiments of the invention described above have a range of advantages. In particular, a reliable monitoring of a technical system can be achieved by means of soft sensor technology using a data-driven model in combination with a density estimator, without the need for an analytical process modelling for corresponding process output parameters. Only input parameters which have a fundamental causal influence on the output parameters need to be determined or known. The corresponding input parameters can be defined with the aforementioned methods from documents [1] and [2] or on the basis of expert knowledge.

The very substantial financial and human resources for the process modelling are almost completely eliminated. Only the parameterization cost for the soft sensor itself remains, but this is essentially limited only to the designation or checking of the process input variables. In addition, a moderate amount of time is required to provide and import the training data, insofar as this is not carried out automatically in the background. The time requirement for the data provision is only a one-off requirement. The time required for the entire training phase is very easily calculable and generally amounts to less than one man month. In the case of the power station application, the data acquired during the commissioning phase can be used for the initial training. Thereafter, the selectivity can be increased as the training adaptation progresses. If the method is embedded into an existing installation infrastructure, the adaptive training phase can be fully automated and requires no human resources.

In the method according to the invention, reference values can be provided for those process variables which were not previously accessible through an analytical process modelling, since the creation of corresponding models was, for example, too complex or not covered by the current state of knowledge. Furthermore, the method according to the invention enables the application of soft sensor technology to regulated process variables which are maintained at a constant value in the operation of the technical system. Many process variables in a technical system are slaved as target parameters to a reference value by means of closed loops. As long as the setting reserve is sufficient, faults in the technical system can be corrected and the regulated target variable remains constant. Especially in the case of multi-channel control systems which depend on many input variables, very different scenarios are conceivable which may result in a controller intervention. With the method according to the invention, controller interventions indicating potential damage to the technical system can now also be established via the forecast of the corresponding regulated variable.

### BIBLIOGRAPHY

[1] WO 2005/033809 A1
[2] WO 2005/081076 A2
[3] German patent application no. 10 2011 081 197.4
[4] WO 2009/053183 A2
[5] International patent application no. PCT/EP 2012/060400
[6] B. Lang et al., Neural Clouds for Monitoring of Complex Systems, Optical Memory and Neural Networks (Information Optics), 2008, Vol. 17, No. 3, pp. 183-192

1. A method for the computer-assisted monitoring of the operation of a technical system, wherein the technical system is characterized at corresponding operating times (t) by a state vector comprising a number of input variables (x(t)) and at least one output variable (y(t)) which is to be monitored, wherein:
a) the at least one output variable (y(t)) is predicted for respective operating times (t) on the basis of input variables occurring in the operation of the technical system with a data-driven model (NN) which is trained by means of training data from known state vectors;
b) at least one density estimator (DE), trained by means of known input variables (x(t)) of the training data, is applied for respective operating times (t) to the number of input variables (x(t)) at the corresponding operating time (t), whereby a confidence measure (C(t)) is defined which is higher the greater the similarity of the input variables (x(t)) at the corresponding operating time (t) to known input variables (x(t)) from the training data;
c) for respective cycles (CY) from a plurality of consecutive operating times (t), a weighted deviation (E(t)), averaged over the number of state vectors in the respective cycle (CY), between the at least one predicted output variable (y(t)) and the at least one output variable (y⁰(t)) occurring in the operation of the technical system is defined, wherein state vectors whose number of input variables have low confidence measures (C(t)) are weighted less in the average weighted deviation;
d) a malfunction of the technical system is detected if all average weighted deviations (E(t)), for a number of consecutive cycles (CY) which is greater than a predefined numerical threshold (Cnt_{Th}), comprising one or more criteria, fulfill the criterion that the amount of these deviations exceeds a predefined threshold value (E_{Th}).

2. The method as claimed in claim 1, in which a malfunction is detected in step d) if all average weighted deviations (E(t)) for a number of consecutive cycles (CY), which is greater than the predefined numerical threshold (Cnt_{Th}), fulfill the further criterion that they correspond to predicted output variables (y(t)) which are always smaller or always greater than the corresponding output variables (y⁰(t)) occurring in the operation of the technical system.

3. The method as claimed in claim 1, in which an alarm is output or another precautionary measure is instigated to protect the technical system if a malfunction of the technical system is detected.

4. The method as claimed in claim 1, in which the at least one output variable (y(t)) comprises a measurement variable in the technical system and/or is determined from one or more measurement variables in the technical system and/or is a variable regulated in the operation of the system.

5. The method as claimed in claim 1, in which the number of input variables (x(t)) contained in a respective state vector is defined on the basis of a trainable statistical model.

6. The method as claimed in claim 1, in which the data-driven model (NN) is based on at least one of a neural network, support vector machines or Gaussian processes.

7. The method as claimed in claim 1, in which the at least one density estimator (DE) is based on a neural clouds algorithm.

8. The method as claimed in claim 1, in which the average weighted deviation (E(t)) is defined in such a way that only state vectors whose number of input variables (x(t)) have confidence measures (C(t)) above a confidence threshold (C_{Th}) are taken into account in the average weighted deviation (E(t)), wherein the state vectors taken into account in the average weighted deviation (E(t)) are equally heavily weighted.

9. The method as claimed in claim 1, in which the predefined threshold value (E_{Th}) is defined according to validation data comprising known state vectors at corresponding operating times (t), wherein the scatter of the deviations between the at least one output variable (y(t)), which is predicted with the trained data-driven model (NN) on the basis of input variables (x(t)) from the validation data, and the at least one input variable (y⁰(t)) which is contained in the state vector (x(t)) of the validation data at the corresponding operating time (t), is defined from the validation data for respective operating times, wherein the predefined threshold (E_{Th}) is determined from the scatter of the deviations in such a way that the greater the predefined threshold (E_{Th}), the greater the scatter.

10. The method as claimed in claim 9, in which the scatter is represented by the standard deviation or variance of the frequency distribution of the deviations determined according to the validation data, or depends on the standard deviation or the variance, wherein the predefined threshold value (E_{Th}) represents the standard deviation or variance multiplied by a positive factor.

11. The method as claimed in claim 1, in which a counter (Cnt(t)) is incremented in step d) whenever the average weighted deviation (E(t)) fulfills the criterion or criteria comprising the criterion that its amount exceeds a predefined threshold value (E_{Th}) for a cycle (CY), wherein, with each incrementation of the counter (Cnt(t)), a warning (W) is output and a malfunction of the technical system is furthermore detected if the incrementation of the counter indicates that the number of temporally consecutive cycles (CY) is greater than the predefined numerical threshold (Cnt_{Th}), wherein the counter (Cnt(t)) is reset to an initial value if the average weighted deviation (E(t)) does not fulfill the criterion or criteria.

12. The method as claimed in claim 11, in which different types of warning (W) are output depending on the number of consecutive cycles (CY) since the resetting of the counter (Cnt(t)) in which the average weighted deviations (E(t)) fulfill the criterion or criteria.

13. The method as claimed in claim 11, in which the warning (W) comprises the output of a signal and/or the sending of a message.

14. The method as claimed in claim 1, in which a training of the data-driven model (NN) and/or the at least one density estimator (DE) is repeated at predefined time intervals with state vectors newly added as training data during the operation of the technical system.

15. The method as claimed in claim 1, in which the technical system is an electrical energy-generating installation comprising a gas turbine.

16. The method as claimed in claim 15, in which the number of input variables and/or the at least one output variable comprise one or more of the following variables of the gas turbine:
the compressor efficiency of the gas turbine;
the turbine efficiency of the gas turbine;
the regulated exhaust gas of the gas turbine;
the setting of one or more guide vanes, in the gas turbine compressor;
the rotational speed of the gas turbine;
one or more pressures and/or temperatures in the gas turbine, including the inlet temperature and/or the inlet pressure and/or the outlet temperature and/or the outlet pressure in the compressor and/or in the turbine;
the temperature in the environment in which the gas turbine is operated;
the relative humidity in the environment in which the gas turbine is operated;
the air pressure in the environment in which the gas turbine is operated;
one or more mass and/or volume flows;
one or more parameters of a cooling and/or auxiliary system and/or lubricating oil and/or bearing systems in the gas turbine, including the setting of one or more valves for the supply of cooling air;
the performance of the gas turbine, including a percentage performance value;
the fuel quality of the gas turbine;
the pollutant emission of the gas turbine, including the emission of nitrogen oxides and/or carbon monoxide;
the temperature of one or more turbine vanes of the gas turbine;
the combustion dynamics of the combustion chamber of the gas turbine;
the quantity of gas supplied to the gas turbine;
bearing and/or housing vibrations in the gas turbine.

17. A device for the computer-assisted monitoring of the operation of a technical system, wherein the device comprises a computer which is programmed to carry out the method as claimed in claim 1.

18. A technical system, comprising the device as claimed in claim 17.

19. A computer program product with a program code stored on a non-transitory machine-readable medium which is executable on a computer to carry out the method as claimed in claim 1.

20. A method as claimed in claim 18, wherein said technical system is an electrical energy-generating installation.

21. The method as claimed in claim 6, wherein said neural network is a recurrent neural network.

22. The method as claimed in claim 3, in which the alarm comprises the output of a signal and/or the sending of a message.
